(19) United States
(12) Patent Application Publication
(10) Pub. No.: US 2013/0061938 A1
(43) Pub. Date: Mar. 14, 2013

(54) PRESSURE CONTROLLING SYSTEM AND PRESSURE CONTROLLING METHOD

(71) Applicants: FANG JIANG, Shenzhen City (CN); FA-YE LI, Shenzhen City (CN); SHUN-BAI WU, Shenzhen City (CN); DAI-PING ZHOU, Shenzhen City (CN); HAO-QUAN WU, Shenzhen City (CN); PENG TAN, Shenzhen City (CN); CUI CHEN, Shenzhen City (CN)

(72) Inventors: FANG JIANG, Shenzhen City (CN); FA-YE LI, Shenzhen City (CN); SHUN-BAI WU, Shenzhen City (CN); DAI-PING ZHOU, Shenzhen City (CN); HAO-QUAN WU, Shenzhen City (CN); PENG TAN, Shenzhen City (CN); CUI CHEN, Shenzhen City (CN)

(73) Assignees: HON HAI PRECISION INDUSTRY CO., LTD., Tu-Cheng (TW); HONG FU JIN PRECISION INDUSTRY (ShenZhen) CO., LTD, Shenzhen City (CN)

(21) Appl. No.: 13/467,119

(22) Filed: May 9, 2012

(30) Foreign Application Priority Data
Sep. 9, 2011 (CN) 201110267356.8

(51) Int. Cl. F16K 21/04

(52) U.S. Cl. 137/14; 137/511

(57) ABSTRACT

A pressure controlling system includes a pressurized device, a piston device, and an electromagnetic routing valve. The pressurized device includes a moving cavity, and a receiving cavity adapted to receive liquid. A pipe is connected to the receiving cavity, and the pipe is adapted to connect a hydraulic cylinder plate. A connecting pipe, a noise elimination pipe, a first gas transmitting pipe, and a second gas transmitting pipe are connected to the electromagnetic routing valve. The first gas transmitting pipe and the second gas transmitting pipe are connected to the pressurized device.

### BACKGROUND

1. Technical Field

The present disclosure relates to a pressure controlling system and a pressure controlling method.

2. Description of Related Art

A gate is located on an end of a part made by injection molding. When injection molding of the part is completed, it is necessary to break the gate off from the part. However, the gate often has a large size and a lot of time may be required to remove and trim the gate off the part. Thus, removal of the gate may cause the injection molding process to be less efficient. Therefore, an improved system and method may be desired within the art.

### BRIEF DESCRIPTION OF THE DRAWINGS

Many aspects of the embodiments can be better understood with reference to the following drawings. The components in the drawings are not necessarily drawn to scale, the emphasis instead being placed upon clearly illustrating the principles of the embodiments. Moreover, in the drawings, like reference numerals designate corresponding parts throughout the several views.

FIG. 1 is an exploded, isometric view of a pressure controlling system in accordance with an embodiment.

FIG. 2 is similar to FIG. 1, but viewed from a different aspect.

FIG. 3 is an assembled view of the device or system of FIG. 1.

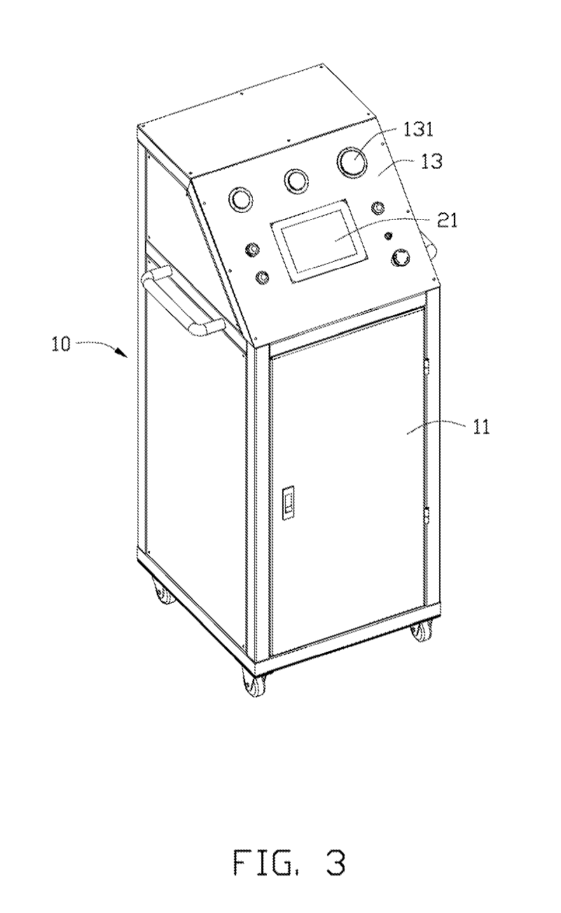

FIG. 4 is a schematic view of the pressure controlling system of FIG. 1.

FIG. 5 is a schematic view of a pipe of the pressure controlling system of FIG. 4 and four modules in accordance with an embodiment.

FIG. 6 is a schematic view of the pressure controlling system of FIG. 1 and a module of FIG. 4 in accordance with an embodiment.

### DETAILED DESCRIPTION

The disclosure is illustrated by way of example and not by way of limitation in the figures of the accompanying drawings in which like references indicate similar elements. It should be noted that references to “an” or “one” embodiment in this disclosure are not necessarily to the same embodiment, and such references mean at least one.

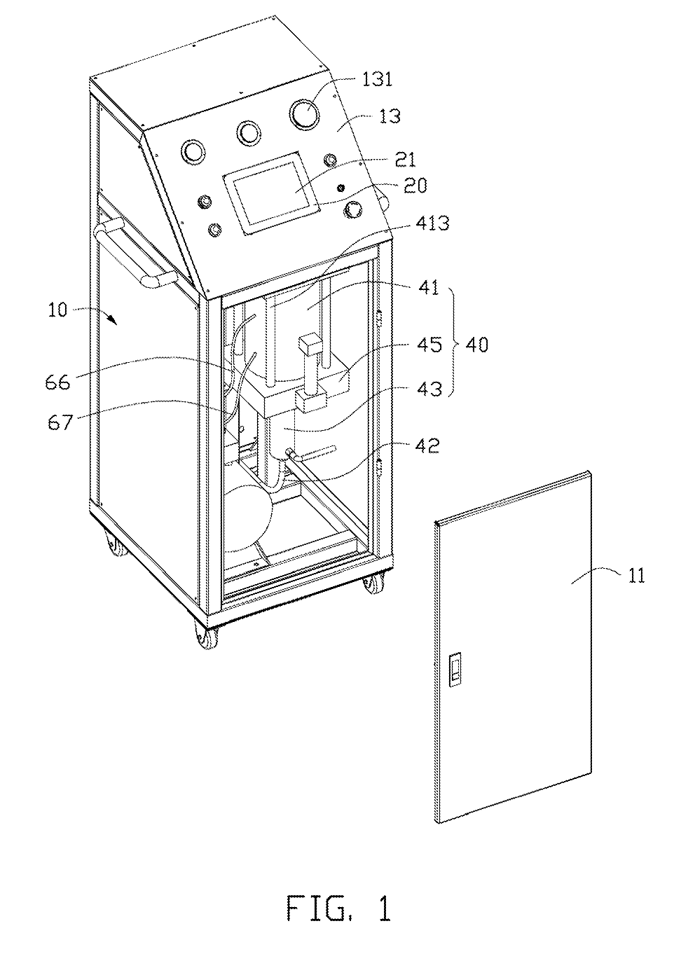

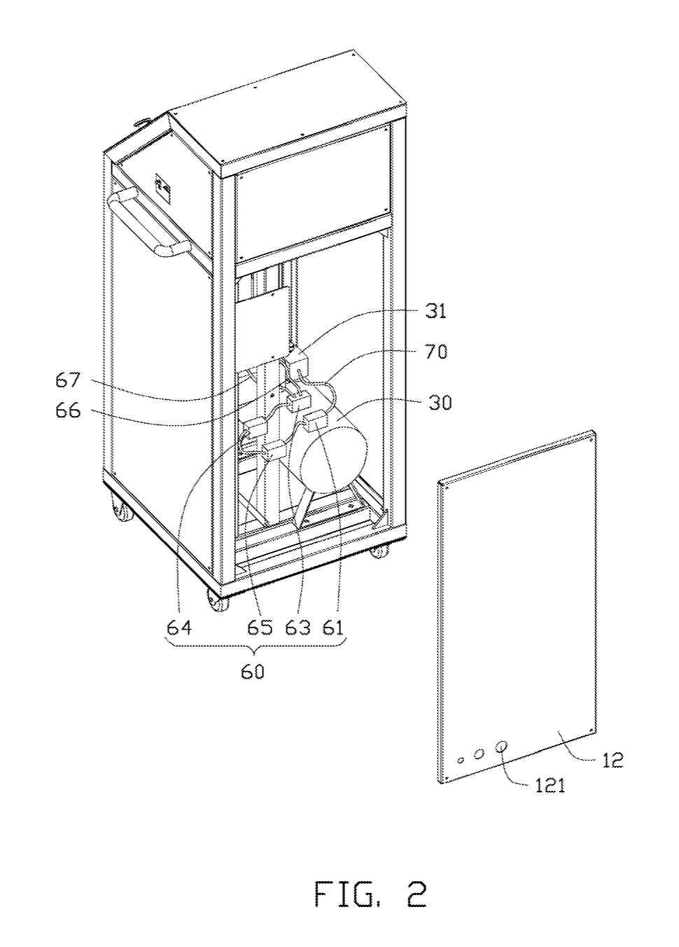

Referring to FIGS. 1 and 2, a pressure controlling system in accordance with an embodiment includes a power supply cabinet 10, a power controlling module 20, a pressurized cabinet 30, and a pressurized device 40 engaged with the pressurized cabinet 30.

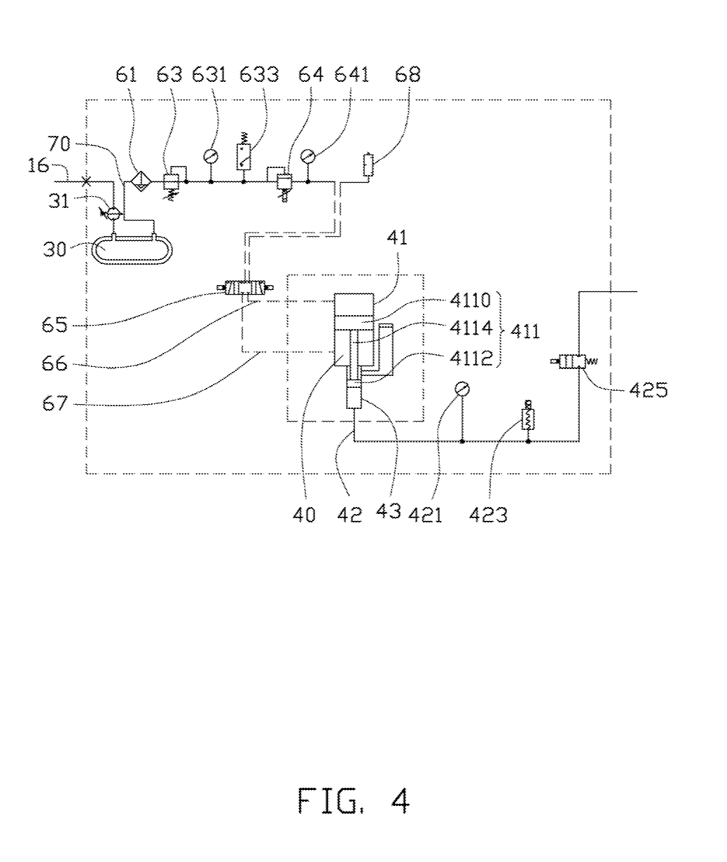

The power supply cabinet 10 includes a door 11, a rear plate 12, and an operating panel 13 connected to the door 11. A through hole 121 is defined in the rear plate 12 for a gas pipe 16 (shown in FIG. 4) extending through. A plurality of displaying modules 131 are located on the operating panel 13. The plurality of displaying modules 131 can be an annunciator or one or more indicator lights.

The power controlling module 20 is secured to the operating panel 13 and used to set parameters. In one embodiment, the parameters include material numbers, pressure values, time, and other values. The power controlling module 20 further includes a display 21 for displaying the parameters.

The pressurized cabinet 30 is connected to a gas transmitting device (not shown) of the power supply cabinet 10 by a pipe (not shown) extending through the through hole 121. A gas with a first pressure value from the gas transmitting device is stored in the pressurized cabinet 30. The pressurized cabinet 30 includes a pressurized valve 31 for increasing the pressure in the pressurized cabinet 30 from the first pressure value to a second pressure value.

Referring to FIG. 4, the pressurized device 40 is connected to the pressurized cabinet 30 by an adjusting valve assembly 60. The adjusting valve assembly 60, secured to a connecting pipe 70, includes a filtrating valve 61, a pressure adjusting valve 63, an inverse proportion valve 64, an electrically operated routing valve 65, a first gas transmitting pipe 66, and a second gas transmitting piece 67.

The filtrating valve 61 is used to filter out impurities passing through the connecting pipe 70. The pressure adjusting valve 63 is used to adjust the second pressure value, and a pressure adjusting meter 631 and a switch 633 are connected to the pressure adjusting valve 63. The pressure adjusting meter 631 is used to display the pressure value, which can be adjusted by the pressure adjusting valve 63. The switch 633 is used to open or close the pressure adjusting valve 63. The inverse proportion valve 64 is used to adjust the second pressure value, which is applied to the pressurized device 40. In one embodiment, an inverse proportion meter 641 is connected to the inverse proportion valve 64, and a range of the second pressure value is 10 kg/cm². The electrically operated routing valve 65 is used to adjust a flow direction of the gas in the pressurized device 40. In one embodiment, the first and the second gas transmitting pipes 66, 67 are located on first side of the electrically operated routing valve 65, and the connecting pipe 70 is located on a second side of the electrically operated routing valve 65.

A noise elimination pipe 68 is connected to the electrically operated routing valve 65. In one embodiment, the electrically operated routing valve 65 is a standard routing device that is used in the industry whereby one or more outlets or inlets (holes) can be opened/connected or closed/disconnected by one or more moving magnetically-responsive barrier(s) which are governed by electromagnetism. Each one of four holes in the electrically operated routing valve 65 communicates with different pipes. For example, the four holes communicate with the first gas transmitting pipe 66, the second gas transmitting pipe 67, the connecting pipe 70 and the noise elimination pipe 68, respectively. A valve(not shown) is located in the shielding cavity, and two electronic magnets(not shown) are received in the shielding cavity. One of the two electronic magnets is electrified, and the barrier can be pointed at the one of the two electronic magnets or moved towards it. Therefore, the hole can be covered by the reorientation or moving of the barrier. For example, the connecting pipe 70 and the first gas transmitting pipe 66 can be opened, or the connecting pipe and the second gas transmitting pipe 67 can be opened, or the first gas transmitting pipe 66 and the noise elimination pipe 68 can be opened, or the second gas transmitting pipe 67 and the noise elimination pipe 68 can be opened.

The pressurized device 40 includes a moving cavity 41, a receiving cavity 43, and a connecting base 45 connected to the moving cavity 41 and the receiving cavity 43. In one embodiment, the pressurized device 40 is received in the interior of the power supply cabinet 10 in a direction substantially parallel to the door 11. The moving cavity 41 includes a piston device 411 and a plurality of strengthening posts 413. The piston device 411 includes a first piston 4110, a second piston 4112, and a connecting portion 4114 connected to the first piston 4110 and the second piston 4112. The first piston 4110 is located in the moving cavity 41, and the second piston 4112 is located in the receiving cavity 43. In one embodiment, a diameter of the first piston 4110 is greater than that of the second piston 4112. The first gas transmitting pipe 66 is above the first piston 4110, and the second gas transmitting pipe 67 is under the first piston 4110.

The receiving cavity 43 is used to receive liquid and a pipe 42 is connected to the bottom of the receiving cavity 43. In one embodiment, the liquid can be oil, which is subject to an original pressure value that is less than the second pressure value. A meter 421, an inducing machine 423 and a direction transferring valve 425 are connected o the pipe 42. The meter 421 is used to display the pressure value in the pipe 42. The inducting machine 423 is used to induce the pressure value in the pipe 42. The direction transferring valve 425 is used to transfer the direction that the oil out of the pipe 42. In one embodiment, the moving cavity 41 and the receiving cavity 43 are cylinders, and a diameter of the moving cavity 41 is greater than that of the receiving cavity 43. A cross-section of the connecting base 45 is a rectangle, and a length of the connecting base 45 is greater than the diameter of the moving cavity 41.

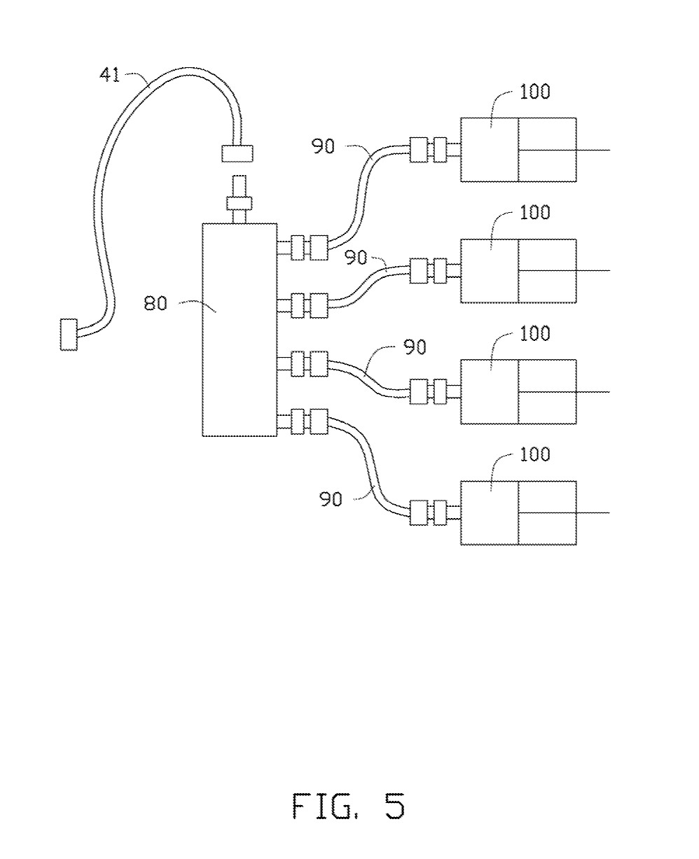

Referring to FIG. 5, the pressure controlling system can be used in manufacturing in a modular fashion. The pipe 42 is connected to a hydraulic cylinder plate 80, and a plurality of sub-pipes 90 are connected to the hydraulic cylinder plate 80. Each of the plurality of sub-pipes 90 is engaged with a module 100.

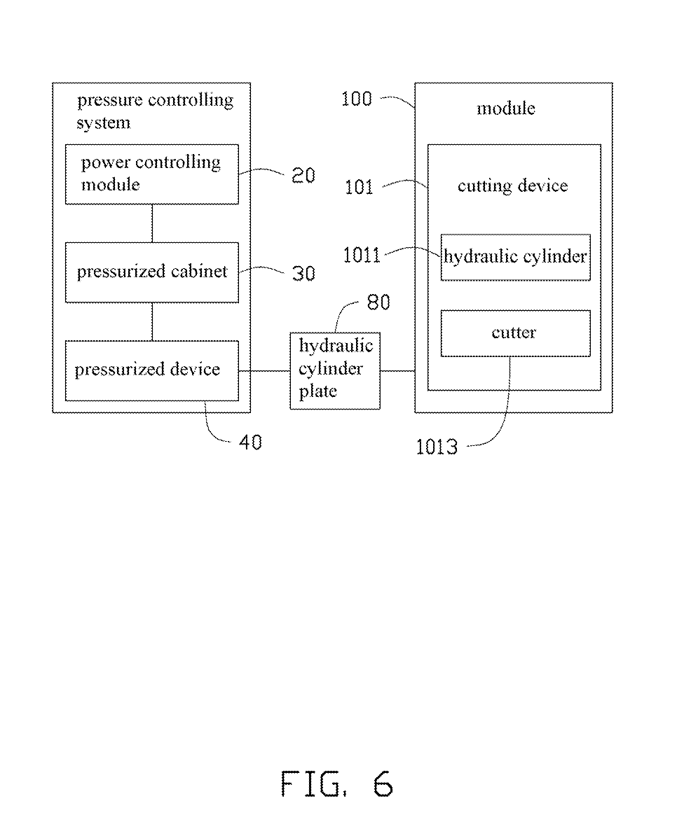

Referring to FIG. 6 (only one module 100 is shown), the module 100 includes a cutting device 101. The cutting device 101 includes a hydraulic cylinder 1011 and a cutter 1013 connected to the hydraulic cylinder 1011. The hydraulic cylinder 1011 can move the cutter 1013 to cut a plastic member (not shown).

Referring to FIGS. 4-6, in use, the power controlling module 20 sets the parameters. The filtrating valve 61, the pressure adjusting valve 63, the inverse proportion valve 64, and the electrically operated routing valve 65 are adjusted. The gas with the first pressure value is transmitted to the pressurized cabinet 30 via the gas pipe 16. The pressurized valve 31 is adjusted to increase the pressure of the gas at the first pressure value to equal the second pressure value. Therefore, the gas with the second pressure value can be transmitted to the pressurized device 40 via the connecting pipe 70 according to the parameters.

When a gate of the plastic member needs to be cut, the electrically operated routing valve 65 is opened to communicate the connecting pipe 70 with the first gas transmitting pipe 66. The gas with the second pressure value can be transmitted to the moving cavity 41 and bear on the first piston 4110, via the first gas transmitting pipe 66. At this time, the gas with the second pressure value is greater than the original pressure value in the moving cavity 41. Thus, the piston device 411 is moved downward to move the liquid out of the receiving cavity 43 to the hydraulic cylinder plate 80 via the pipe 42. Simultaneously, the electrically operated routing valve 65 is opened to communicate the second gas transmitting pipe 67 with the noise elimination pipe 68. The gas can be move out of the receiving cavity 43 from the second gas transmitting pipe 67 with the noise elimination pipe 68. Therefore, a gas with a third pressure value is located in the moving cavity 41, and the third pressure value is less than the second pressure value. The liquid, that is transmitted to the hydraulic cylinder plate 80, is divided between the four of the sub-pipes 90. Therefore, the gas can be transmitted to the hydraulic cylinder 1011 via the sub-pipes 90. The hydraulic cylinder 1011 moves the cutter 1013 to cut the gate of the plastic member.

After the gate of the plastic member has been cut, the electrically operated routing valve 65 is opened to communicate the connecting pipe 70 with the second gas transmitting pipe 67. The gas with the second pressure value is transmitted to the receiving cavity 43. The gas with the second pressure value is greater than that the gas with the third pressure value, and the piston device 411 is moved upward. Therefore, the liquid is moved back to the receiving cavity 43 via the sub-pipes 90, the hydraulic cylinder plate 80, and the pipe 42 in turn. Simultaneously, the electrically operated routing valve 65 is opened to communicate the first gas transmitting pipe 66 with the noise elimination pipe 68, and the gas moves out of the moving cavity 41 via the first gas transmitting pipe 66 and the noise elimination pipe 68. Then the piston device 411 ceases working, to await a subsequent process.

It is to be understood, however, that even though numerous characteristics and advantages have been set forth in the foregoing description of embodiments, together with details of the structures and functions of the embodiments, the disclosure is illustrative only and changes may be made in detail, especially in the matters of shape, size, and arrangement of parts within the principles of the disclosure to the full extent indicated by the broad general meaning of the terms in which the appended claims are expressed.

What is claimed is:

1. A pressure controlling system comprising:
a pressurized device comprising a moving cavity and a receiving cavity connected to the moving cavity, the receiving cavity being adapted to receive liquid, and a pipe connected to the receiving cavity and being adapted to connect a hydraulic cylinder plate;
a piston device located in the pressurized device;
an electrically operated routing valve, a connecting pipe, a noise elimination pipe, a first gas transmitting pipe, and a second gas transmitting pipe connected to the electrically operated routing valve; each of the first gas transmitting pipe and the second gas transmitting pipe being connected to the pressurized device;
wherein the piston device pumps the liquid out of the receiving cavity via the pipe and into the hydraulic cylinder plate when the first gas transmitting pipe communicates with the connecting pipe, the second gas transmitting pipe communicates with the noise elimination pipe, and gas from the connecting pipe is transmitted to the moving cavity by the first gas transmitting pipe; and the piston device pumps the liquid from the hydraulic cylinder into the receiving cavity via the pipe when the first gas transmitting pipe communicates with the connecting pipe, and the gas is back to the moving cavity via the second gas transmitting pipe,

2. The pressure controlling system of claim 1, wherein the piston device comprises a first piston located between the moving cavity and the receiving cavity, the first gas transmitting pipe communicates with the moving cavity, and the second gas transmitting pipe communicates with the receiving cavity.

3. The pressure controlling system of claim 1, wherein a cross-section of the moving cavity is circle.

4. The pressure controlling system of claim 1, wherein the pressurized device further comprises a connecting base connected to the moving cavity and the receiving cavity, and a plurality of strengthening posts are connected to the connecting base and surround on the moving cavity.

5. The pressure controlling system of claim 3, wherein a cross-section of the receiving cavity is a circle, and a diameter of the receiving cavity is less than a diameter of the moving cavity.

6. The pressure controlling system of claim 1, further comprising a pressurized cabinet adapted to receive a first gas with a first pressure value, and a pressurized valve is attached to the pressurized cabinet for increasing the first gas with the first pressure value to a second gas with a second pressure value.

7. The pressure controlling system of claim 6, further comprising a power supply cabinet configured to receive the pressurized cabinet and the pressurized device, a power controlling module is attached to the power supply cabinet, and the power controlling module is adapted to set parameters.

8. The pressure controlling system of claim 7, wherein the power supply cabinet comprises a door, and the pressurized device is received in the power supply cabinet in a direction substantially parallel to the door.

9. The pressure controlling system of claim 1, wherein a filtrating valve is attached to the connecting pipe, and the filtrating valve is adapted to filtrate impurities out of the gas.

10. The pressure controlling system of claim 1, wherein an inverse proportion valve is attached to the connecting pipe, and the inverse proportion valve is adapted to adjust a pressure value of gas in the pressurized device.

11. A pressure controlling method comprising:
setting parameters by a power controlling module;
receiving liquid by a receiving cavity of a pressurized device;
providing a first air passage between a first gas transmitting pipe and a connecting pipe, and providing a second air passage between a second gas transmitting pipe and a noise elimination pipe;
transmitting a gas to the moving cavity by a connecting pipe and the first gas transmitted pipe; and
pumping the liquid out of the receiving cavity by a piston device and flowing the liquid into the hydraulic cylinder plate by a pipe.

12. The pressure controlling method of claim 11, further comprising providing the first air passage between the first gas transmitting pipe and the connecting pipe, flowing the gas into the moving cavity by the second gas transmitting pipe, and pumping the liquid into the receiving cavity by the piston device driving via the pipe and the hydraulic cylinder plate.

13. The pressure controlling method of claim 11, further comprising moving the moving cavity to the receiving cavity by a first piston, the first piston being located between the moving cavity and the receiving cavity.

14. The pressure controlling method of claim 11, wherein a connecting base is connected to the moving cavity and the receiving cavity, and a plurality of strengthening posts are connected to the connecting base and surround on the moving cavity.

15. The pressure controlling method of claim 14, wherein a cross-section of the receiving cavity is a circle, a cross-section of the moving cavity is a circle, and a diameter of the receiving cavity is less than a diameter of the moving cavity.

16. The pressure controlling method of claim 11, further comprising receiving a first gas with a first pressure value by a pressurized cabinet, and increasing the first gas with the first pressure value to a second gas with a second pressure value by a pressurized valve.

17. The pressure controlling method of claim 11, further comprising filtrating impurity of the gas by a filtrating valve.

18. The pressure controlling method of claim 11, further comprising adjusting a pressure value of the gas in a pressurized device by an inverse proportion valve.
